(19) United States
(12) Patent Application Publication
(10) Pub. No.: US 2020/0204238 A1
(43) Pub. Date: Jun. 25, 2020

(54) BASE STATION DEVICE AND TERMINAL, AND METHOD FOR ALLOCATING WIRELESS CHANNEL

(71) Applicant: SK TELECOM CO., LTD., Seoul (KR)

(72) Inventors: Min Soo NA, Seoul (KR); Chang Soon CHOI, Seoul (KR)

(21) Appl. No.: 15/751,710

(22) PCT Filed: May 20, 2016
(86) PCT No.: PCT/KR2016/005363

§ 371 Date: Feb. 9, 2018

(30) Foreign Application Priority Data
Oct. 5, 2015 (KR) 10-2015-0139964

(51) Int. Cl. H04B 7/06; H04B 7/0456; H04W 16/14; H04W 24/10; H04W 72/04; H04W 88/08; H04W 88/06

(52) U.S. Cl. CPC H04B 7/0626; H04B 7/0632; H04B 7/0456; H04W 88/06; H04W 24/10; H04W 72/048; H04W 88/08; H04W 16/14

(57) ABSTRACT

The present disclosure proposes a base station device, a terminal, and a method for allocating a wireless channel in which a base station device receives two or more channel state information from each of terminals in a cell in a wireless environment that overlappingly allocates the same wireless channel (frequency and time resources) in the same cell, so it is possible to perform redundant physical downlink allocation transmission based on the same precoding, whereby it is possible to improve wireless efficiency and cell capacitance.

### BACKGROUND OF THE INVENTION

### 1. Field of the Invention

The present disclosure relates to a method of increasing the number of terminal to which the same wireless channel can be allocated by determining the number of channel state information, which is transmitted from the terminal to a base station, to be two or more under a wireless environment where the same wireless channel (frequency and time resources) is overlappingly allocated in the cell.

### 2. Description of the Prior Art

As the types of communication services and the required transmission speeds are become more various in an LTE communication system, expansion of LTE frequencies and evolution toward a 5G communication system is being rapidly made.

With the development of communication system, it has been required to increase the frequency capacitance in a cell. To this end, several forms of non-orthogonal multiple access technologies such as non-orthogonal multiple access (NOMA) is considered.

Non-orthogonal multiple access technology is to simultaneously transmit data to two or more terminals at the same time, frequency, and space resources.

Non-orthogonal multiple access technology overlappingly allocates the same wireless channel (frequency and time resources) to two or more terminals, so it is expected to improve the efficiency of a frequency, as compared with a technology that allocates different wireless channels (frequency resources) to each terminal.

In order to increase the frequency capacity in the 5G communication system, it is required to increase the number of terminal to which same wireless resource can be overlappingly allocated for non-orthogonal multiple access techniques.

### SUMMARY OF THE INVENTION

The present disclosure has been made in consideration of this situation and an aspect of the present disclosure is to increase the number of terminal to which the same wireless channel can be allocated by determining the number of channel state information, that is transmitted from the terminal to a base station, to be two or more under a wireless environment in which the same wireless channel can be overlappingly allocated in the same cell.

In accordance with an aspect of the present disclosure, there is provided a base station device including: a determiner configured to determine the number of channel state information to be two or more; a transmitter configured to transmit the number of channel state information to terminal in a cell; a receiver configured to receive two or more channel state information from the terminal in accordance with the number of channel state information; a generator configured to generate a terminal group by grouping terminal having the same channel state information on the basis of the two or more channel state information, thereby the number of grouped terminal being able to be increased as compared with a case where the number of channel state information is one; and an allocator configured to allocate the same wireless channel to the terminal included in the terminal group.

Specifically, the number of the terminal group or the number of grouped terminal may be increased as compared with the case where the number of channel state information is one, when terminal group is generated by grouping terminal having the same channel state information on the basis of the two or more channel state information.

Specifically, each of the two or more channel state information may be generated in relation to at least one wireless channel of a plurality of wireless channels in the cell, and the at least one wireless channel may have quality measured by the terminal being a threshold value or more.

Specifically, each of the two or more channel state information may include a precoding matrix index and a channel quality indicator in relation to the measured quality, and a precoding matrix index and a channel quality indicator of one terminal in a specific terminal group may be the same as a precoding matrix index and a channel quality indicator of the other terminal in the specific terminal group.

Specifically, the number of channel state information may be included in a radio resource control message that is transmitted to the terminal initially connected to the cell by the base station device, and the two or more channel state information may be received from the terminal through a physical uplink control channel or a physical uplink shared channel.

In accordance with another aspect of the present disclosure, there is provided a terminal including: a receiver configured to receive the number of channel state information, the number of channel state information being determined to be two or more by a base station device configured to allocate a wireless channel on the basis of channel state information; a generator configured to generate two or more channel state information in accordance with the determined number of channel state information; and a transmitter configured to transmit the two or more channel state information to the base station device, so that a possibility of same wireless channel being allocated to terminals in a cell is increased as compared with a case where one channel state information is transmitted.

Specifically, each of the two or more channel state information may be generated in relation to at least one wireless channel of a plurality of wireless channels in the cell, and the at least one wireless channel may have quality measured by the terminal being a threshold value or more.

Specifically, each of the two or more channel state information may include a precoding matrix index and a channel quality indicator that are related to the measured quality, and a precoding matrix index and a channel quality indicator of the terminal may be the same as a precoding matrix index and a channel quality indicator of the other terminal in the cell.

Specifically, the number of channel state information may be included in a radio resource control message that is received from the base station device when being initially connected to the cell, and the two or more channel state information may be transmitted to the base station device through a physical uplink control channel or a physical uplink shared channel.

In accordance with another aspect of the present disclosure, there is provided a method for allocating a wireless channel, the method including: determining the number of channel state information to be two or more channel state information; transmitting the number of channel state information to terminal in a cell, through a base station device; receiving the two or more channel state information from the terminal in accordance with the number of channel state information; generating a terminal group by grouping terminal having the same channel state information on the basis of the two or more channel state information, thereby the number of grouped terminal being able to be increased as compared with a case where the number of channel state information is one; and allocating the same wireless channel to the terminal included in the terminal group, through a base station device.

Specifically, the number of the terminal group or the number of grouped terminal may be increased as compared with the case where the number of channel state information is one, when terminal group is generated by grouping terminal having the same channel state information on the basis of the two or more channel state information.

Specifically, each of the two or more channel state information may be generated in relation to at least one wireless channel of a plurality of wireless channels in the cell, and the at least one wireless channel may have quality measured by the terminal being a threshold value or more.

Specifically, each of the two or more channel state information may include a precoding matrix index and a channel quality indicator in relation to the measured quality, and a precoding matrix index and a channel quality indicator of one terminal in a specific terminal group may be the same as a precoding matrix index and a channel quality indicator of the other terminal in the specific terminal group.

Specifically, the number of channel state information may be included in a radio resource control message that is transmitted to the terminal initially connected to the cell by the base station device, and the two or more channel state information may be received from the terminal through a physical uplink control channel or a physical uplink shared channel.

Therefore, according to the base station device, the terminal, and the method for allocating a wireless channel according to an embodiment of the present disclosure, it is possible to increase the number of terminal to which the same wireless channel can be allocated by determining the number of channel state information, that is transmitted from the terminal to a base station, to be two or more under a wireless environment where the same wireless channel (frequency and time resources) is overlappingly allocated in the cell. Therefore, it is possible to improve wireless efficiency and cell capacitance.

### BRIEF DESCRIPTION OF THE DRAWINGS

FIG. 1 is an exemplary diagram showing a wireless environment according to an embodiment of the present disclosure;

FIG. 2 is a diagram illustrating frequency resource allocation according to non-orthogonal multiple access according to an embodiment of the present disclosure;

FIG. 3 is a diagram illustrating the configuration of a base station device according to an embodiment of the present disclosure;

FIG. 4 is a diagram illustrating transmission power allocation according to an embodiment of the present disclosure;

FIG. 5 is a diagram illustrating the configuration of a terminal according to an embodiment of the present disclosure;

FIG. 6 is a diagram illustrating operation flow in a wireless channel allocation system according to an embodiment of the present disclosure;

FIG. 7 is a diagram illustrating operation flow in a base station device according to an embodiment of the present disclosure; and

FIG. 8 is a diagram illustrating operation flow in a terminal according to an embodiment of the present disclosure.

### DETAILED DESCRIPTION OF THE EXEMPLARY EMBODIMENTS

Hereinafter, an embodiment of the present disclosure will be described with reference to accompanying drawings.

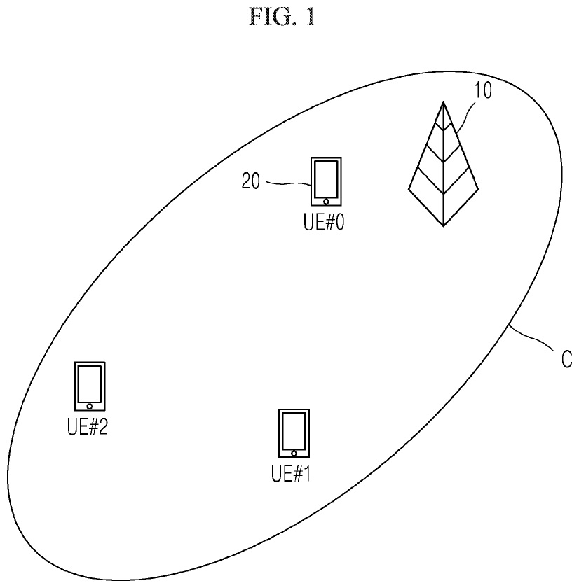

FIG. 1 shows a wireless environment according to an embodiment of the present disclosure.

As shown in FIG. 1, the wireless environment according to an embodiment of the present disclosure may include a base station device 10 and a plurality of terminals 20 (UE #0, UE #1, UE #2) located in a cell C.

The base station device 10 may generate the cell C and provide a mobile communication service to the terminals 20 (UE #0, UE #1, UE #2) located in the cell C. For example, the base station device 10 may be a NodeB or an eNodeB.

In order to maximize the frequency capacitance in the cell C, the base station device 10 may be implemented based on a close loop-multi input multi output (CS-MIMO) system.

Further, the terminals 20 (UE #0, UE #1, UE #2) may be mobile or fixed user nodes such as user equipment (UE) or a mobile station (MS).

The wireless environment according to an embodiment of the present disclosure follows several forms of non-orthogonal multiple access technology such as a non-orthogonal multiple access (NOMA) in order to increase the frequency capacitance in the cell.

As described above, the non-orthogonal multiple access technology is to simultaneously transmit data to two or more terminals at the same time, frequency, and space resources.

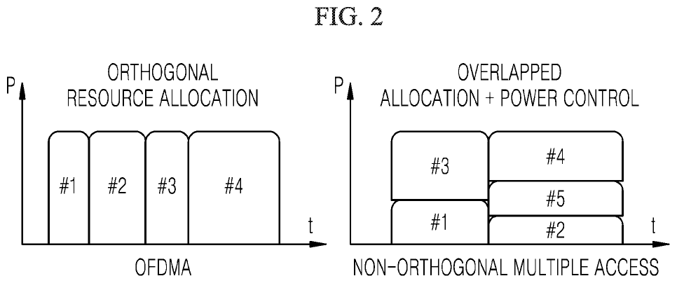

In FIG. 2, the methods of allocating frequency resources by orthogonal frequency division multiplexing access (OFDMA) and non-orthogonal multiple access are illustrated.

As shown in FIG. 2, it can be seen that OFDMA allocates different frequency resources to terminals in a cell while maintaining the orthogonal feature of frequency resources. To the contrary, non-orthogonal multiple access overlappingly allocates the same frequency resource to two or more terminals. In this case, the orthogonal feature of frequency resources is not maintained.

According to non-orthogonal multiple access, the frequency efficiency is improved as compared with OFDMA that allocates different frequency resources to terminals since non-orthogonal multiple access overlappingly allocates the same frequency resource to two or more terminals. Thus, it is possible to increase the frequency capacitance in a cell according to non-orthogonal multiple access.

Non-orthogonal multiple access is described in detail hereafter.

When the wireless environment according to an embodiment of the present disclosure follows non-orthogonal multiple access, the terminals 20 (UE #0, UE #1, UE #2) in the cell C periodically transmit channel state information (CSI) to the base station device 10. The channel state information is information needed for scheduling wireless channels (frequency and time resources).

The channel state information is related to the result of measuring the qualities of several wireless channels by the terminals 20 (UE #0, UE #1, UE #2) in the cell C. For example, a precoding matrix index (PMI), a channel quality indicator (CQI), and a rank indicator (RI) may be included in the channel state information.

Based on the channel state information for the terminals 20 (UE #0, UE #1, UE #2) in the cell C, the base station device 10 generates terminal group by grouping terminals with same precoding matrix index and same channel quality indicator. Then, the same frequency resource is overlappingly allocated to the grouped terminals and data is simultaneously transmitted.

The terminals 20 (UE #0, UE #1, UE #2) in the cell C may generate and transmit only one channel state information related to a specific wireless channel to the base station device 10. The specific wireless channel may have the highest quality of the wireless channels in the cell C

The base station device 10 receives the channel state information from each of the terminals 20 (UE #0, UE #1, UE #2) in the cell C and checks whether a precoding matrix index and a channel quality indicator of one terminal is same as a precoding matrix index and a channel quality indicator of the other terminal. The base station device 10 may group terminals with same precoding matrix index and same channel quality indicator into one group and allocates the same wireless channel (frequency and time resources) to the terminals in the one group.

Since the base state device 10 generates terminal groups using only one channel state information received from each of the terminals 20 (UE #0, UE #1, UE #2) in the cell C, the number of the terminals grouped into terminal group can be limited.

Accordingly, there is a limit in satisfying the frequency capacitance required for the future 5G communication system when the existing non-orthogonal multiple access is applied without modification.

Accordingly, an embodiment of the present disclosure is intended to propose a method for grouping more terminals into a terminal group as compared with a case using only one channel state information for each terminal when non-orthogonal multiple access technology is applied. To this end, an embodiment of the present disclosure determines that each of the terminals 20 (UE #0, UE #1, UE #2) in the cell C can transmit two or more channel state information

The configurations of a wireless channel allocation system, a base station device 10, and terminals 20 (UE #0, UE #1, UE #2) for accomplishing the method are described hereafter.

First, a wireless channel allocation system according to an embodiment of the present disclosure is described hereafter. The configuration of the wireless channel allocation system according to an embodiment of the present disclosure may have the same as the configuration of a wireless environment according to an embodiment of the present disclosure described above with reference to FIG. 1.

A base station device 10 performs a function of determining the number of channel state information.

Specifically, the base station device 10 determines the number of channel state information received from each of terminals 20 (UE #0, UE #1, UE #2) in the cell C. The channel state information may be used for scheduling wireless channels (frequency and time resources).

The base station device 10 determines the number of channel state information as two or more when the non-orthogonal multiple access is applied.

The number of channel state information is related to the number of terminals to which the same wireless channel (frequency and time resources) is allocated in the cell C. For example, the number of channel state information may be determined as 2 or a larger number in consideration of interference among terminals to which the same wireless channel (frequency and time resources) is applied or depending on the setting by a system operator.

Further, the base station device 10 performs a function of transmitting the number of channel state information.

Specifically, when the number of channel state information received from each of the terminals 20 (UE #0, UE #1, UE #2) in the cell C is determined, the base station device 10 transmits the determined number of channel state information to the terminals 20 (UE #0, UE #1, UE #2) in the cell C.

When the terminals 20 (UE #0, UE #1, UE #2) are initially connected to the cell C, the base station device 10 can transmit information about the determined number of channel state information to the terminals 20 (UE #0, UE #1, UE #2) in the cell C through a radio resource control (RRC) message.

The terminals 20 (UE #0, UE #1, UE #2) in the cell C perform a function of generating channel state information.

Specifically, when the terminals 20 (UE #0, UE #1, UE #2) in the cell C recognize the number of channel state information from the base station device 10 through initial connection to the cell C, each of the terminals 20 (UE #0, UE #1, UE #2) generates two or more channel state information corresponding to the recognized number of channel state information.

The terminals 20 (UE #0, UE #1, UE #2) in the cell C measure the qualities of a plurality of wireless channels in the cell and select two or more wireless channels based on the number of channel state information determined by the base station device 10 in descending order of quality. Then, the terminals 20 (UE #0, UE #1, UE #2) generate two or more channel state information related to the selected two or more wireless channels.

For example, the channel state information may include a precoding matrix index (PMI) related to a specific precoding matrix used for measuring the quality by the terminals 20 (UE #0, UE #1, UE #2), a channel quality indicator (CQI) related to the measured quality, and a rank indicator (RI).

Further, the terminals 20 (UE #0, UE #1, UE #2) in the cell C perform a function of transmitting channel state information.

Specifically, after two or more channel state information is generated in accordance with the number of channel state information determined by the base station device 10, the terminals 20 (UE #0, UE #1, UE #2) in the cell C transmit the generated two or more channel state information to the base station device 10. The two or more channel state information can be used for scheduling.

For example, the terminals 20 (UE #0, UE #1, UE #2) in the cell C can transmit two or more channel state information to the base station device 10 through a physical uplink control channel (PUCCH) or a physical uplink shared channel (PUSCH).

Further, the base station device 10 performs a function of generating terminal groups.

Specifically, when two or more channel state information is received from each of the terminals 20 (UE #0, UE #1, UE #2) in the cell C, the base station device 10 compares the two or more channel state information received from each of the terminals 20 (UE #0, UE #1, UE #2) and generates terminal group by grouping terminals having the same channel state information.

The base station device 10 compares a precoding matrix index and a channel quality indicator of one channel state information received from the terminals 20 (UE #0, UE #1, UE #2) to these of the other channel state information. The base station device 10 can group terminals having the same the precoding matrix index and the same channel quality indicator into a terminal group. For the grouped terminals, same wireless channel (frequency and time resources) is applied.

Further, the base station device 10 performs a function of allocating a wireless channel (frequency and time resources).

Specifically, after generating a terminal group by grouping terminals having the same precoding matrix index and channel quality indicator in channel state information, the base station device 10 allocates the same frequency resource to the terminal in each of the generated terminal group. Then the base station device 10 performs scheduling to be able to simultaneously transmit downlink data at the allocated frequency resource.

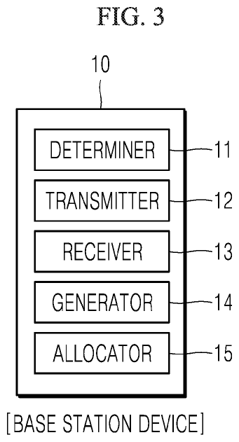

The description of the wire channel allocation system according to an embodiment of the present disclosure is described above. The configuration of the base station device 10 according to an embodiment of the present disclosure is described hereafter with reference to FIG. 3.

As shown in FIG. 3, the base station device 10 according to an embodiment of the present disclosure may having a configuration including a determiner 11 configured to determine the number of channel state information, a transmitter 12 configured to transmit the determined number of channel state information, a receiver 13 configured to receive channel state information corresponding to the determined number of channel state information, a generator 14 configured to generate terminal groups, and an allocator 15 configured to allocate a wireless channel (frequency and time resources).

All or at least a portion of the configuration of the base station device 10 including the determiner 11, transmitter, 12, receiver 13, generator 14, and allocator 15 can be implemented as a software module or a hardware module, or as a combination of a software module and a hardware module.

The base station device 10 according to an embodiment of the present disclosure can determine the number of channel state information received from each of the terminals 20 (UE #0, UE #1, UE #2) in the cell C to be two or more. In this case, the number of terminal which is grouped into a terminal group can be larger as compared with a case using one channel state information. The components of the base station device 10 are described hereafter.

The determiner 11 performs a function of determining the number of channel state information.

Specifically, the determiner 11 determines the number of channel state information. The number of channel state is received from each of the terminals 20 (UE #0, UE #1, and UE #2) in the cell C for scheduling wireless channels (frequency and time resource).

The determiner 11 determines the number of channel state information as two or more when the non-orthogonal multiple access technology is applied.

A transmitter 12 performs a function of transmitting the number of channel state information.

Specifically, when the number of channel state information that is to be received from each of the terminals 20 (UE #0, UE #1, UE #2) in the cell C is determined, the transmitter 12 transmits the determined number of channel state information to the terminals 20 (UE #0, UE #1, UE #2) in the cell C.

When the terminals 20 (UE #0, UE #1, UE #2) are initially connected to the cell C, the transmitter 12 can transmit information about the determined number of channel state information to the terminals 20 (UE #0, UE #1, UE #2) in the cell C through a radio resource control (RRC) message.

After the terminals 20 (UE #0, UE #1, UE #2) in the cell C recognizes the number of channel state information from the base station device 10, the terminals 20 (UE #0, UE #1, UE #2) measure the qualities of a plurality of wireless channels in the cell and select two or more wireless channels corresponding to the number of channel state information determined by the base station device 10 in descending order of quality. Then, channel state information may be generated for each the selected two or more wireless channels, respectively.

Further, the receiver 13 performs a function of receiving two or more channel state information from each of the terminals 20 (UE #0, UE #1, UE #2) in the cell C.

Specifically, the receiver 13 receives two or more channel state information generated by each of the terminals 20 (UE #0, UE #1, UE #2) in the cell C. The number of two or more channel state information corresponds to the determined number of channel state information.

For example, the receiver 13 can receive two or more channel state information from each of the terminals 20 (UE #0, UE #1, UE #2) in the cell C through a physical uplink control channel (PUCCH) or a physical uplink shared channel (PUSCH).

The generator 14 performs a function of generating terminal group.

Specifically, when two or more channel state information is received from each of the terminals 20 (UE #0, UE #1, UE #2) in the cell C, the generator 14 compares the two or more channel state information received from each of the terminals 20 (UE #0, UE #1, UE #2) to each other. Then the generator 14 groups terminal having the same channel state information, thereby generating terminal group.

The generator 14 compares a precoding matrix index and a channel quality indicator of one channel state information received from the terminals 20 (UE #0, UE #1, UE #2) to these of the other channel state information. The base station device 10 can group terminals having the same the precoding matrix index and the same channel quality indicator into a terminal group. For the grouped terminals, same wireless channel (frequency and time resources) is applied.

The allocator 15 performs a function of allocating a wireless channel (frequency and time resources).

Specifically, after a terminal group is generated by grouping terminals having the same values of the precoding matrix index and channel quality indicator in channel state information, the allocator 15 allocates the same frequency resource to the terminal in the generated terminal group. Then, the allocator 15 may perform scheduling to be able to simultaneously transmit downlink data at the allocated frequency resource.

For the terminals included in the terminal group, it may be guaranteed that the value of channel quality indicator using a specific precoding vector is same. Therefore that it is possible to transmit data using the same precoder.

The allocator 15 allocates transmission power for transmitting data to each of the terminals included in the terminal group to minimize interference among the terminals to which the same frequency resource is allocated.

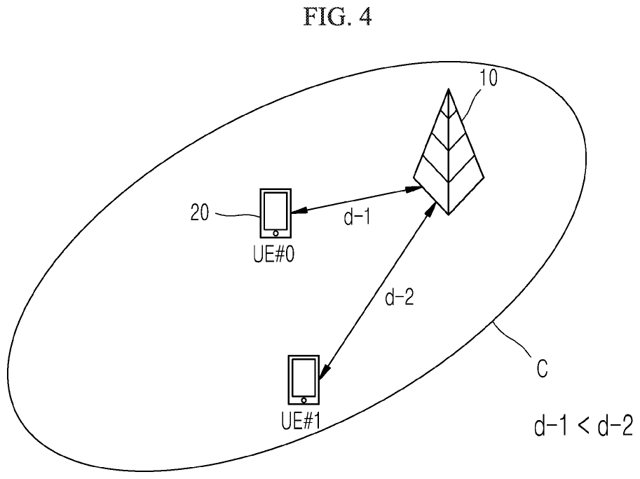

For example, FIG. 4 shows a first terminal UE #0 and a second terminal UE #1 grouped into a terminal group.

As shown in FIG. 4, it can be seen that the distance d-1 between the first terminal UE #0 and the base station device 10 is longer than the distance d-2 between the second UE #1 and the base station device 10.

In this case, the allocator 15 may allocate smaller transmission power to the first terminal UE #0 closer to the base station device 10, while it may allocate larger transmission power to the second terminal UE #1 farther from the base station device 10.

Accordingly, the first terminal UE #0 closer to the base station device 10 decodes and removes an interference signal from the second terminal UE #1 having larger signal intensity and then decodes its own signal. For example, successive interference cancellation (SIC) may be applied.

On the other hand, the second terminal UE #1 farther from the base station device 10 receives a relatively weak interference signal from the first terminal UE #0. Thus the second terminal UE #1 decodes its own signal while treating the interference signal as interference.

For reference, the following Table 1 shows the transmission power that can be allocated to the first terminal UE #0 and the second terminal UE #1 in association with a specific frequency resource when the terminals are not grouped into a terminal group. In addition, the following Table 1 also shows the transmission power that can be allocated to the first terminal UE #0 and the second terminal UE #1 in association with a specific frequency resource when the terminals are grouped into a terminal group.

TABLE 1

| | Transmission | Transmission |
|---|---|---|
| | power for first | power for second |
| Terminal Group | terminal UE#0 | terminal UE#1 |
| Terminal Group (X) | 1 | 0 |
| Terminal Group (X) | 0 | 1 |
| Terminal Group (◯) | 0.1 | 0.9 |
| Terminal Group (◯) | 0.9 | 0.1 |
| Terminal Group (◯) | 0.2 | 0.8 |
| Terminal Group (◯) | 0.8 | 0.2 |

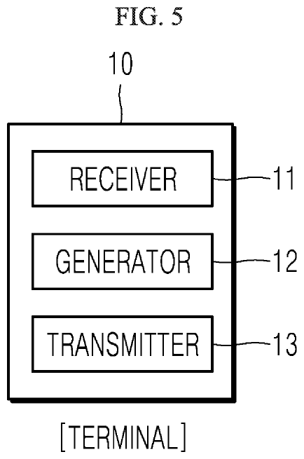

The description of the configuration of the base station device 10 according to an embodiment of the present disclosure is described above. The configuration of the terminal 20 (UE #0) according to an embodiment of the present disclosure is described hereafter with reference to FIG. 5.

As shown in FIG. 5, the terminal 20 (UE #0) according to an embodiment of the present disclosure may have a configuration including a receiver 21 configured to receive a determined number of channel state information, a generator 22 configured to generate channel state information, and a transmitter 23 configured to transmit channel state information.

All of at least a portion of the configuration of the terminal 20 (UE #0) including the receiver 21, generator 22, and transmitter 23 can be implemented as a software module or a hardware module, or as a combination of a software module and a hardware module.

The terminal 20 (UE #0) according to an embodiment of the present disclosure generates and transmits two or more channel state information to the base station device 10. In this case, it is possible to increase the possibility that the terminal 20 (UE #0) can be grouped into a terminal group together with other terminals UE #1 and UE #2, as compared with a case of transmitting one channel state information. The configuration of the terminal 20 is described in detail hereafter.

A receiver 21 performs a function of receiving the number of channel state information.

Specifically, the receiver 21 receives information of the number of channel state information, which is determined to be two or more, from the base station device 10.

In this regard, the base station 10 determines the number of channel state information for scheduling wireless channels (frequency and time resources). The channel state information is received from each of the terminals 20 (UE #0, UE #1, UE #2) in the cell C. When the terminals 20 (UE #0, UE #1, UE #2) are initially connected to the cell C, the base station device 10 transmits the information of the determined number of channel state information to the terminals 20 (UE #0, UE #1, UE #2) in the cell C through a radio resource control (RRC) message.

The generator 22 performs a function of generating channel state information.

Specifically, when the number of channel state information is identified from the base station device 10 through initial connection to the cell C, the generator 22 generates two or more channel state information based on the recognized number of channel state information.

The generator 22 measures the qualities of a plurality of wireless channels in the cell and selects two or more wireless channels corresponding to the number of channel state information determined by the base station device 10 in descending order of quality. Then, channel state information is generated for each the selected two or more wireless channels, respectively.

The channel state information may include a precoding matrix index (PMI) related to a specific precoding matrix used for measuring the quality by the terminals 20 (UE #0, UE #1, and UE #2), a channel quality indicator (CQI) related to the measured quality, and a rank indicator (RI).

A transmitter 23 performs a function of transmitting channel state information.

Specifically, when two or more channel state information are generated in accordance with the number of channel state information determined by the base station device 10, the transmitter 23 transmits the generated two or more channel state information to the base station device 10. Then the channel state information can be used for scheduling.

For example, the transmitter 23 can transmit two or more channel state information to the base station device 10 through a physical uplink control channel (PUCCH) or a physical uplink shared channel (PUSCH).

Specifically, when two or more channel state information is received from each of the terminals 20 (UE #0, UE #1, UE #2) in the cell C, the base station device 10 compares the two or more channel state information received from each of the terminals 20 (UE #0, UE #1, UE #2) to each other. Then the base station device 10 groups terminals having the same channel state information for generating terminal groups.

The base station device 10 compares a precoding matrix index and a channel quality indicator of one channel state information received from the terminals 20 (UE #0, UE #1, UE #2) to these of the other channel state information. The base station device 10 can group terminals having the same the precoding matrix index and the same channel quality indicator into a terminal group. For the grouped terminals, same wireless channel (frequency and time resources) is applied.

When a terminal group is generated by grouping terminals having the same values of the precoding matrix index and channel quality indicator in channel state information, the base station device 10 can allocate the same frequency resource to the terminals in the generated terminal group and perform scheduling to simultaneously transmit downlink data at the allocated frequency resource.

As described above, according to the wireless channel allocation system, the base station device 10, and the terminal 20 (UE #0) according to an embodiment of the present disclosure, terminals with the same channel state information of the terminals 20 (UE #0, UE #1, UE #2) in the cell C may be grouped into a terminal group and the same wireless channel (frequency and time resources) is overlappingly allocated to the terminals in the terminal group. It is possible to group more terminals into a terminal group, as compared with a case of one channel state information, by determining the number of channel state information that each of the terminals 20 (UE #0, UE #1, UE #2) can transmit is determined to be two or more. Therefore, the number of terminals to which the same wireless channel (frequency resource) can be allocated in the cell is increased, and it is possible to considerably improve the frequency efficiency.

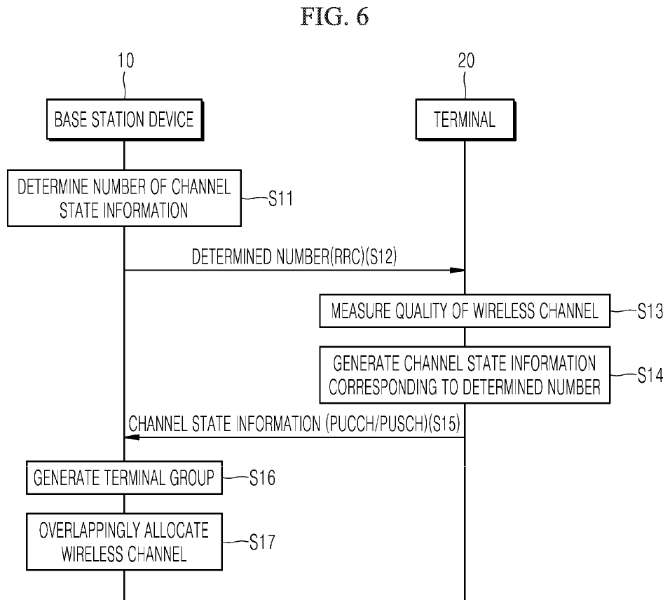

The operation flow in the wireless channel allocation system, the base station device 10, and the terminal 20 (UE #0) according to an embodiment of the present disclosure is described hereafter with reference to FIGS. 6 to 8.

The operation flow of the wireless channel allocation system is described first with reference to FIG. 6.

First, the base station device 10 determines the number of channel state information in step S11. The channel state information is received from each of the terminals 20 (UE #0, UE #1, UE #2) in the cell C for scheduling wireless channels (frequency and time resources).

The base station device 10 determines the number of channel state information to be two or more when the existing non-orthogonal multiple access is applied.

Then, when the number of channel state information received from each of the terminals 20 (UE #0, UE #1, UE #2) in the cell C is determined, the base station device 10 transmits the determined number of channel state information to the terminals 20 (UE #0, UE #1, UE #2) in the cell C.

When the terminals 20 (UE #0, UE #1, UE #2) are initially connected to the cell C, the base station device 10 can transmit information about the determined number of channel state information to the terminals 20 (UE #0, UE #1, UE #2) in the cell C through a radio resource control (RRC) message.

Next, when the terminals 20 (UE #0, UE #1, UE #2) in the cell C recognize the number of channel state information from the base station device 10 through initial connection to the cell C, each of the terminals 20 (UE #0, UE #1, UE #2) generates two or more channel state information corresponding to the recognized number of channel state information in step S13 and step S14.

The terminals 20 (UE #0, UE #1, UE #2) in the cell C measure the qualities of a plurality of wireless channels in the cell and select two or more wireless channels corresponding to the number of channel state information determined by the base station device 10 in descending order of quality. Each of the terminals 20 (UE #0, UE #1, UE #2) generates channel state information for each of the selected two or more wireless channels, respectively.

The channel state information may include a precoding matrix index (PMI) related to a specific precoding matrix used for measuring the quality by the terminals 20 (UE #0, UE #1, and UE #2), a channel quality indicator (CQI) related to the measured quality, and a rank indicator (RI).

Then, after two or more channel state information is generated in accordance with the number of channel state information determined by the base station device 10, each of the terminals 20 (UE #0, UE #1, UE #2) in the cell C transmits the generated two or more channel state information to the base station device 10 in step S15. The channel state information can be used for scheduling.

For example, each of the terminals 20 (UE #0, UE #1, UE #2) in the cell C can transmit two or more channel state information to the base station device 10 through a physical uplink control channel (PUCCH) or a physical uplink shared channel (PUSCH).

Further, when two or more channel state information is received from each of the terminals 20 (UE #0, UE #1, UE #2) in the cell C, the base station device 10 compares the two or more channel state information received from the terminals 20 (UE #0, UE #1, UE #2) to each other and groups terminals having the same channel state information to generate terminal groups in step S16.

The base station device 10 compares a precoding matrix index and a channel quality indicator of one channel state information received from the terminals 20 (UE #0, UE #1, UE #2) to these of the other channel state information. The base station device 10 can group terminals having the same the precoding matrix index and the same channel quality indicator into a terminal group. For the grouped terminals, same wireless channel (frequency and time resources) is applied.

Thereafter, when a terminal group is generated by grouping terminals having the same values of the precoding matrix index and channel quality indicator in channel state information, the base station device 10 allocates the same frequency resource to the terminals in the generated terminal group and performs scheduling to simultaneously transmit downlink data at the allocated frequency resource in step S17.

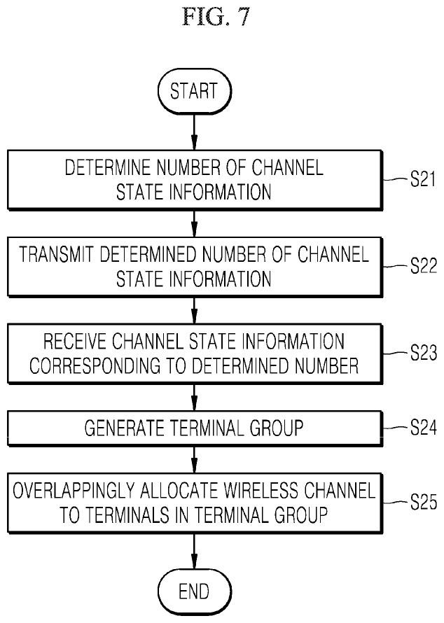

The description of the operation flow of the wireless channel allocation system according to an embodiment of the present disclosure is described above. The operation flow of the base station 10 according to an embodiment of the present disclosure is described hereafter with reference to FIG. 7.

First, the determiner 11 determines the number of channel state information in step S21. The channel state information is received from each of the terminals 20 (UE #0, UE #1, UE #2) in the cell C for scheduling wireless channels (frequency and time resources).

The determiner 11 determines the number of channel state information to be two or more, when the non-orthogonal multiple access is applied.

Then, when the number of channel state information received from each of the terminals 20 (UE #0, UE #1, UE #2) in the cell C is determined, the transmitter 12 transmits the determined number of channel state information to the terminals 20 (UE #0, UE #1, UE #2) in the cell C in step S22.

In this process, when the terminals 20 (UE #0, UE #1, UE #2) are initially connected to the cell C, the transmitter 12 can transmit information about the determined number of channel state information to the terminals 20 (UE #0, UE #1, UE #2) in the cell C through a radio resource control (RRC) message.

After recognizing the number of channel state information from the base station device 10, the terminals 20 (UE #0, UE #1, UE #2) in the cell C measure the qualities of a plurality of wireless channels in the cell and select two or more wireless channels corresponding to the number of channel state information determined by the base station device 10 in descending order of quality. The channel state information is generated for each of the selected two or more wireless channels, respectively.

Further, the receiver 13 receives two or more channel state information generated by each of the terminals 20 (UE #0, UE #1, UE #2) in the cell C in step S23. The number of two or more channel state information corresponds to the determined number of channel state information.

For example, the receiver 13 can receive two or more channel state information from each of the terminals 20 (UE #0, UE #1, UE #2) in the cell C through a physical uplink control channel (PUCCH) or a physical uplink shared channel (PUSCH).

Next, when two or more channel state information are received from each of the terminals 20 (UE #0, UE #1, UE #2) in the cell C, the generator 14 compares the two or more channel state information received from each of the terminals 20 (UE #0, UE #1, UE #2) to each other and groups terminals having the same channel state information to generate terminal group in step S24.

The base station device 10 compares a precoding matrix index and a channel quality indicator of one channel state information received from the terminals 20 (UE #0, UE #1, UE #2) to these of the other channel state information. The base station device 10 can group terminals having the same the precoding matrix index and the same channel quality indicator into a terminal group. For the grouped terminals, same wireless channel (frequency and time resources) is applied.

Thereafter, when a terminal group is generated by grouping terminals having the same values of the precoding matrix index and channel quality indicator in channel state information, the allocator 15 allocates the same frequency resource to the terminals in the generated terminal group and performs scheduling to simultaneously transmit downlink data at the allocated frequency resource in step S25.

The allocator 15 allocates transmission power for transmitting data to the terminals included in the terminal group to minimize interference among the terminals to which the same frequency resource is allocated.

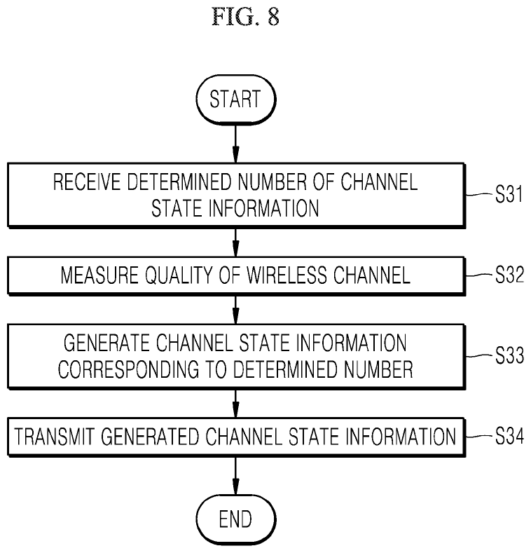

The description of the operation flow of the base station device 10 according to an embodiment of the present disclosure is described above. The operation of the terminal 20 (UE #0) according to an embodiment of the present disclosure is described hereafter with reference to FIG. 8.

First, the receiver 21 receives the number of channel state information from the base station device 10 in step S31. The number of channel state information is determined to be two or more.

The base station 10 determines the number of channel state information to be two or more. The channel state information is received from each of the terminals 20 (UE #0, UE #1, UE #2) in the cell C for scheduling wireless channels (frequency and time resources). When the terminals 20 (UE #0, UE #1, UE #2) are initially connected to the cell C, the base station device 10 transmits the information of the determined number of channel state information to the terminals 20 (UE #0, UE #1, UE #2) in the cell C through a radio resource control (RRC) message.

Next, when the generator 22 recognizes the number of channel state information from the base station device 10 through initial connection to the cell C, it generates two or more channel state information based on the recognized number of channel state information in step 32 and step 33.

The generator 22 measures the qualities of a plurality of wireless channels in the cell and selects two or more wireless channels corresponding to the number of channel state information determined by the base station device 10 in descending order of quality. The channel state information is generated for each of the selected two or more wireless channels.

The channel state information may include a precoding matrix index (PMI) related to a specific precoding matrix used for measuring the quality by the terminals 20 (UE #0, UE #1, and UE #2), a channel quality indicator (CQI) related to the measured quality, and a rank indicator (RI).

Next, when two or more channel state information are generated in accordance with the number of channel state information determined by the base station device 10, the transmitter 23 transmits the generated two or more channel state information to the base station device 10, so that the channel state information can be used for scheduling in step S34.

In relation to this process, for example, the transmitter 23 can transmit two or more channel state information to the base station device 10 through a physical uplink control channel (PUCCH) or a physical uplink shared channel (PUSCH).

Specifically, when receiving two or more channel state information from each of the terminals 20 (UE #0, UE #1, UE #2) in the cell C, the base station device 10 compares the two or more channel state information received from each of the terminals 20 (UE #0, UE #1, UE #2) to each other and groups terminals having the same channel state information to generate terminal group.

The base station device 10 compares a precoding matrix index and a channel quality indicator of one channel state information received from the terminals 20 (UE #0, UE #1, UE #2) to these of the other channel state information. The base station device 10 can group terminals having the same the precoding matrix index and the same channel quality indicator into a terminal group. For the grouped terminals, same wireless channel (frequency and time resources) is applied.

As a result, when a terminal group is generated by grouping terminals having the same values of the precoding matrix index and channel quality indicator in channel state information, the base station device 10 can allocate the same frequency resource to the terminals in the generated terminal group and perform scheduling to simultaneously transmit downlink data at the allocated frequency resource.

As described above, according to the operation flow of the wireless channel allocation system, the base station device 10, and the terminal 20 (UE #0) according to an embodiment of the present disclosure, terminals with the same channel state information of the terminals 20 (UE #0, UE #1, UE #2) in the cell C may be grouped into a terminal group and the same wireless channel (frequency and time resources) is overlappingly allocated to the terminals in the terminal group. It is possible to group more terminals into a terminal group, as compared with a case of one channel state information, by determining the number of channel state information that each of the terminals 20 (UE #0, UE #1, UE #2) can transmit is determined to be two or more. Therefore, the number of terminals to which the same wireless channel (frequency resource) can be allocated in the cell is increased, and it is possible to considerably improve the frequency efficiency.

Meanwhile, the method described in connection with the provided embodiments or steps of the algorithm may be implemented in a form of a program command, which can be executed through various computer means, and recorded in a computer-readable recording medium. The computer readable medium may include a program command, a data file, a data structure, and the like independently or in combination. The program command recorded in the medium may be things specially designed and configured for the present disclosure, or things that are well known to and can be used by those skilled in the computer software related art. Examples of the computer-readable recording medium include magnetic media such as hard disks, floppy disks and magnetic tapes, optical media such as a Compact Disc Read-Only Memory (CD-ROM) and a Digital Versatile Disc (DVD), magneto-optical media such as floppy disks, and hardware devices such as a Read-Only Memory (ROM), a Random Access Memory (RAM) and a flash memory, which are specially configured to store and perform program instructions. Examples of the program command include a machine language code generated by a compiler and a high-level language code executable by a computer through an interpreter and the like. The hardware device may be configured to operate as one or more software modules in order to perform operations of the present disclosure, and vice versa.

Although the present disclosure has been described in detail with reference to exemplary embodiments, the present disclosure is not limited thereto and it is apparent to those skilled in the art that various modifications and changes can be made thereto without departing from the scope of the present disclosure.

What is claimed is:

1. A base station device comprising:
a determiner configured to determine the number of channel state information to be two or more;
a transmitter configured to transmit the number of channel state information to a terminal in a cell;
a receiver configured to receive two or more channel state information from the terminal in accordance with the number of channel state information;
a generator configured to generate a terminal group by grouping terminal having the same channel state information on the basis of the two or more channel state information, thereby the number of grouped terminal being able to be increased as compared with a case where the number of channel state information is one; and
an allocator configured to allocate the same wireless channel to the terminal included in the terminal group.

2. The base station device of claim 1, wherein the number of the terminal group or the number of grouped terminal is increased as compared with the case where the number of channel state information is one, when terminal group is generated by grouping terminal having the same channel state information on the basis of the two or more channel state information.

3. The base station device of claim 1, wherein each of the two or more channel state information is generated in relation to at least one wireless channel of a plurality of wireless channels in the cell,
wherein the at least one wireless channel has quality measured by the terminal being a threshold value or more.

4. The base station device of claim 3, wherein each of the two or more channel state information includes a precoding matrix index and a channel quality indicator in relation to the measured quality, and
a precoding matrix index and a channel quality indicator of one terminal in a specific terminal group are the same as a precoding matrix index and a channel quality indicator of the other terminal in the specific terminal group.

5. The base station device of claim 1, wherein the number of channel state information is included in a radio resource control message that is transmitted to the terminal initially connected to the cell by the base station device, and
the two or more channel state information are received from the terminal through a physical uplink control channel or a physical uplink shared channel.

6. A terminal comprising:
a receiver configured to receive the number of channel state information, the number of channel state information being determined to be two or more by a base station device configured to allocate a wireless channel on the basis of channel state information;
a generator configured to generate two or more channel state information in accordance with the determined number of channel state information; and
a transmitter configured to transmit the two or more channel state information to the base station device, so that a possibility of same wireless channel being allocated to terminals in a cell is increased as compared with a case where one channel state information is transmitted.

7. The terminal of claim 6, wherein each of the two or more channel state information is generated in relation to at least one wireless channel of a plurality of wireless channels in the cell,
wherein the at least one wireless channel has quality measured by the terminal being a threshold value or more.

8. The terminal of claim 7, wherein each of the two or more channel state information includes a precoding matrix index and a channel quality indicator that are related to the measured quality, and
a precoding matrix index and a channel quality indicator of the terminal are the same as a precoding matrix index and a channel quality indicator of the other terminal in the cell.

9. The terminal of claim 6, wherein the number of channel state information is included in a radio resource control message that is received from the base station device when being initially connected to the cell, and
the two or more channel state information are transmitted to the base station device through a physical uplink control channel or a physical uplink shared channel.

10. A method for allocating a wireless channel, the method comprising:
determining the number of channel state information to be two or more;
transmitting the number of channel state information to terminal in a cell;
receiving two or more channel state information from the terminal in accordance with the number of channel state information;
generating a terminal group by grouping terminal having the same channel state information on the basis of the two or more channel state information, thereby the number of grouped terminal being able to be increased as compared with a case where the number of channel state information is one; and
allocating the same wireless channel to the terminal included in the terminal group.

11. The method of claim 10, the number of the terminal group or the number of grouped terminal is increased as compared with the case where the number of channel state information is one, when terminal group is generated by grouping terminal having the same channel state information on the basis of the two or more channel state information.

12. The method of claim 10, wherein each of the two or more channel state information is generated in relation to at least one wireless channel of a plurality of wireless channels in the cell,
wherein the at least one wireless channel has quality measured by the terminal being a threshold value or more.

13. The method of claim 12, wherein each of the two or more channel state information includes a precoding matrix index and a channel quality indicator in relation to the measured quality, and
a precoding matrix index and a channel quality indicator of one terminal in a specific terminal group are the same as a precoding matrix index and a channel quality indicator of the other terminal in the specific terminal group.

14. The method of claim 10, wherein the number of channel state information is included in a radio resource control message that is transmitted to the terminal initially connected to the cell by the base station device, and
the two or more channel state information are received from the terminal through a physical uplink control channel or a physical uplink shared channel.
